(19) United States
(12) Patent Application Publication
(10) Pub. No.: US 2025/0350345 A1
(43) Pub. Date: Nov. 13, 2025

(54) TRACKING AREA UPDATE SYSTEMS AND METHODS FOR AERIAL USER EQUIPMENT IN WIRELESS COMMUNICATION NETWORKS

(71) Applicant: AT&T Technical Services Company, Inc., Vienna, VA (US)

(72) Inventor: Daniel Vivanco, Ashburn, VA (US)

(73) Assignee: AT&T Technical Services Company, Inc., Vienna, VA (US)

(21) Appl. No.: 18/659,196

(22) Filed: May 9, 2024

(51) Int. Cl. H04B 7/185; H04W 48/04

(52) U.S. Cl. CPC H04B 7/18504; H04W 48/04

(57) ABSTRACT

Aspects of the subject disclosure may include, for example, identifying that a type of a user equipment (UE) is an unmanned aerial vehicle (UAV) attached to a serving cell included in a target area; upon the identification of the UAV, determining that the UAV is in an idle mode and sending a notification to the UAV; receiving, from the UAV, a message including a requested periodicity of a tracking area update (TAU); upon the receiving of the requested periodicity of the TAU, updating a TAU periodicity to be aligned with the requested periodicity of the TAU; and mandating the serving cell of the UAV to send to the UAV an updated message including the updated ATU periodicity. The TAU periodicity is indicative of a transmission frequency of a TAU message by the UE to a network counterpart. Other embodiments are disclosed.

### FIELD OF THE DISCLOSURE

The subject disclosure relates to tracking area update systems and methods for aerial user equipment in wireless communication networks.

### BACKGROUND

Applications for unmanned aerial vehicles (UAVs) are emerging and can provide a potential business area for mobile operators. Use cases of commercial UAVs are growing rapidly, including delivery, communications and media, inspection of critical infrastructure, surveillance, search-and-rescue operations, agriculture, etc. Research and development of current LTE mobile broadband communication has been primarily devoted to terrestrial communication. Providing tether-less broadband connectivity for unmanned aerial vehicles (UAVs) is an emerging field.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A depicts a wireless communication network environment involving a tracking area (TA) update of a user equipment (UE).

FIG. 2B depicts an illustrative embodiment of a method in accordance with various aspects described herein.

FIG. 2C depicts an illustrative embodiment of another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for tracking area update systems and methods for aerial user equipment (UE) in wireless communication networks. The systems and methods provide a mechanism for fast paging and fast response for aerial UEs, while the aerial UEs are in an idle mode. Other embodiments are described in the subject disclosure.

One or more aspects of the subject disclosure are directed to a device including a processing system including a processor and a memory that stores executable instructions that, when executed by the processing system, facilitate performance of operations. The operations include receiving user equipment (UE) identification of a UE operating in a tracking area, wherein the tracking area (TA) comprises a cluster of base stations having a same tracking area code and represents an area where the UE was last registered; based on the received UE identification, identifying that a type of UE is an unmanned aerial vehicle (UAV) attached to a serving cell included in the cluster of base stations; upon the identification of the UAV, determining that the UAV is in an idle mode and sending a notification to the UAV; receiving, from the UAV, a message including a requested periodicity of a tracking area update (TAU); upon the receiving of the requested periodicity of the TAU, updating a TAU periodicity to be aligned with the requested periodicity of the TAU; and mandating the serving cell of the UAV to send to the UAV an updated message including the updated periodicity of the TAU. The TAU periodicity is indicative of a transmission frequency of a TAU message by the UE to a network counterpart.

One or more aspects of the subject disclosure are directed to a machine-readable medium, comprising executable instructions that, when executed by a processing system of an aerial user equipment including a processor, facilitate performance of operations. The operations include receiving a configuration message including a periodicity of a tracking area update (TAU) during an initial attachment, where the TAU periodicity is indicative of a transmission frequency of a TAU message over a predetermined period of time by an aerial user equipment (UE) to a network counterpart element; sending the TAU message to the network counterpart element via a serving cell according to the TAU periodicity; collecting operation conditions of the aerial UE, where the aerial UE operates as an autonomous vehicle; transmitting a requested periodicity of the TAU based on the collected operation conditions of the aerial UE; receiving, via the serving cell, a reconfiguration message including an updated periodicity of the TAU message that is consistent with the requested periodicity of the TAU; and transmitting, over a predetermined period of time, the TAU message a number of times determined based on the updated periodicity included in the reconfiguration message.

One or more aspects of the subject disclosure are directed to a method including identifying, by a processing system including a processor, a type of user equipment (UE) and an unmanned state of the UE, based on a UE identifier; upon the identification that the type of user equipment corresponds to an unmanned aerial UE attached to a wireless communication network, determining, by the processing system, that the unmanned aerial UE is in an idle mode; upon the determined idle mode, sending, by the processing system, a paging message to a last serving cell included in a tracking area update (TAU) message that have received from the unmanned aerial UE; receiving, by the processing system, from the unmanned aerial UE, a requested periodicity of the TAU; upon the receiving of the requested periodicity of the TAU, updating, by the processing system, a TAU periodicity reflecting the requested periodicity of the TAU, wherein the TAU periodicity is indicative of a transmission frequency of a TAU message over a preset period of time by the UE to a network counterpart; and mandating, by the processing system, a serving cell of the unmanned aerial UE to send an updated message including the updated periodicity of the TAU.

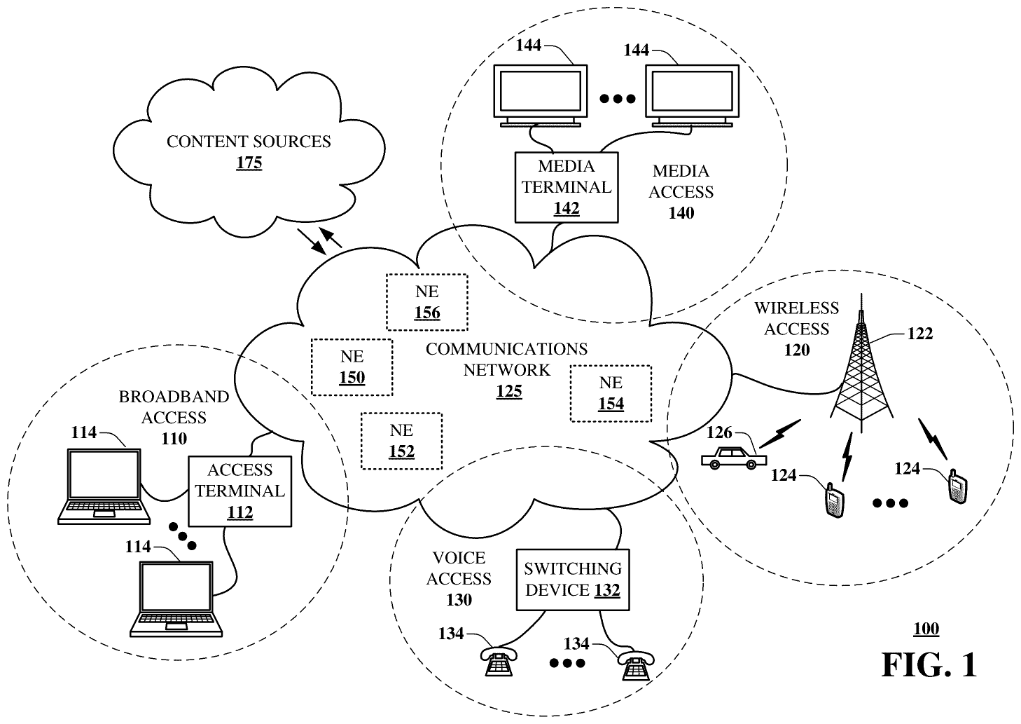

Referring now to FIG. 1, a block diagram is shown illustrating an example, non-limiting embodiment of a system 100 in accordance with various aspects described herein. For example, system 100 can facilitate in whole or in part tracking area update systems and methods for aerial user equipment in wireless communication networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

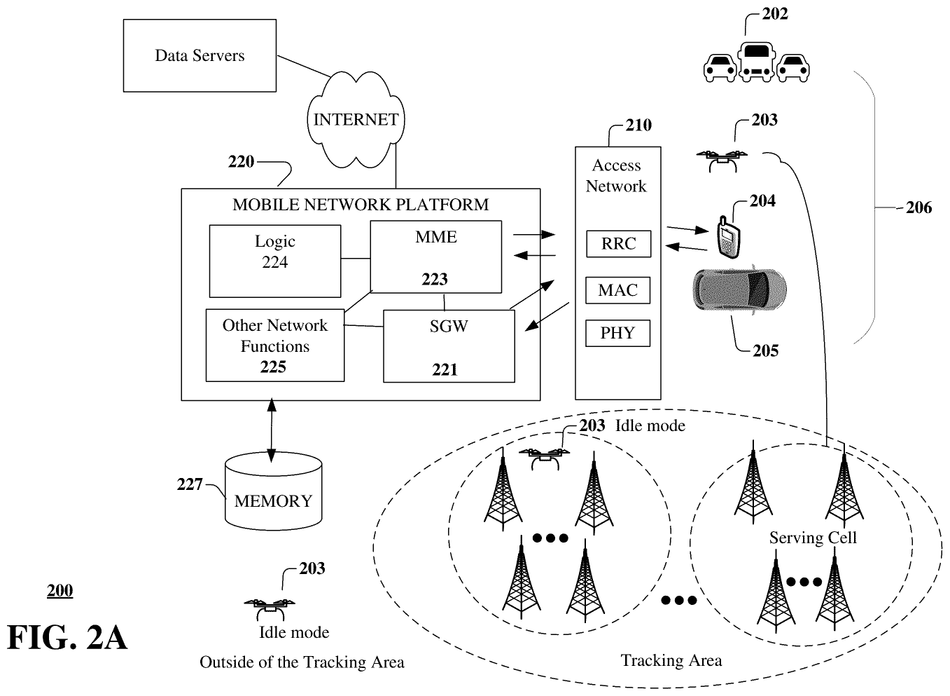

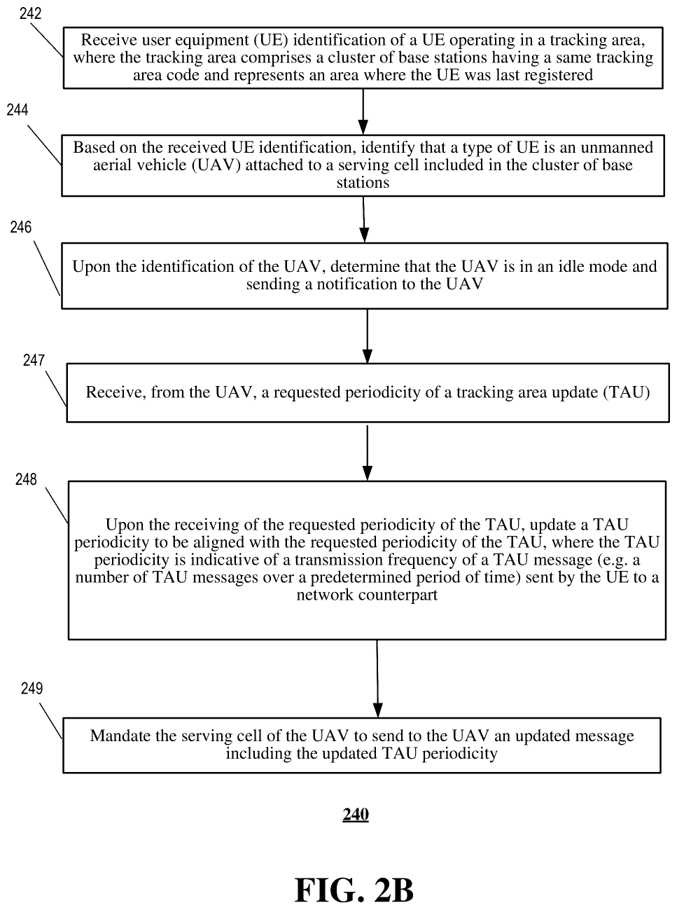

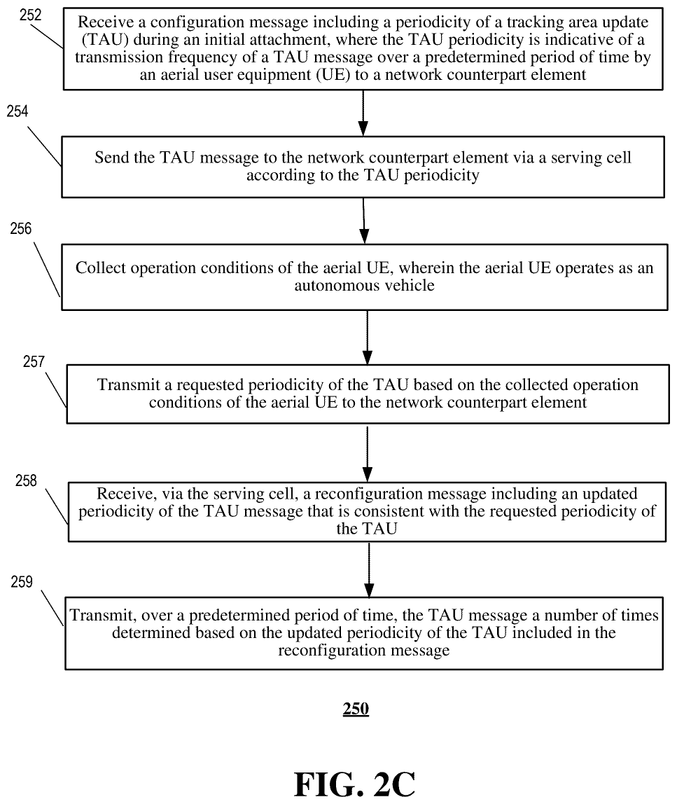

FIG. 2A is a block diagram illustrating an example, non-limiting embodiment of a tracking area update system (“the system”) 200 functioning within the communication network of FIG. 1 in accordance with various aspects described herein. The system 200 includes a plurality of different user equipment 202, 203, 204 and 205. The user equipment 202, 203, 204 and 205 are connected to an access network 210 which is connected to a mobile network platform 220. The user equipment 202, 203, 204 and 205 are connected to the internet via the access network 210 and the mobile network platform 220. The user equipment 202, 203, 204 and 205 (collectively, user equipment (UE) 206) have access to data servers via the internet.

In various embodiments, the mobile network platform 220 may include network devices and/or systems that provide a variety of functions. In certain embodiments, the mobile network platform 220 may be implemented in a cloud architecture. In some embodiments, the mobile network platform 220 implement LTE networks. In the LTE networks, examples of network functions provided by, or included, in the mobile network platform 220 include a Mobility Management Entity (MME) function 223, a Serving Gateway (SGW) 221 and other network functions 225 such as a Packet Data Network Gateway (PGW), Home Subscriber Server (HSS), etc. The MME 223 is responsible for an idle mode of user equipment (UE) by handling paging and tagging procedures. The MME 223 further handles selecting a serving gateway for a UE at an initial attachment and at the time of intra-LTE handover. The MME 223 is also involved with authentication of a user by interacting with the HSS and

FIG. 2A depicts that the mobile network platform 220 implements the LTE networks, but the present disclosure is not limited thereto. The mobile network platform 220 facilitates and support 5G, 6G, or any higher generation of cellular networks. Although not shown in the drawings, in the 5G networks, examples of functions provided by, or included, in the mobile network platform 220 include an access mobility function (AMF) configured to facilitate mobility management in a control plane of the network system (including, for instance, providing UE mobility information associated with the access network(s) 210 and/or the UE 206 to the mobile network platform 220), a user plane function (UPF) configured to provide access to a data network, such as a packet data network (PDN), in a user (or data) plane of the network system 200, a Unified Data Management (UDM) function, a Session Management Function (SMF), a policy control function (PCF), and/or the like. The mobile network platform 220 may be in communication with one or more other networks (e.g., one or more content delivery networks (CDNs)), one or more services, and/or one or more devices. In one or more embodiments, the mobile network platform 220 may include one or more devices implementing other functions, such as a master user database server device for network access management, a PDN gateway server device for facilitating access to a PDN, and/or the like. The mobile network platform 220 may include various physical/virtual resources, including server devices, virtual environments, databases, and so on.

In various embodiments, the access network 210 may include a wireless radio access network (RAN), a Wi-Fi network, and/or a wireline network. In exemplary embodiments, the access network 210 may be implemented in open source software (e.g., in an OpenAirInterface (OAI) wireless technology platform). The access network 210 may include network resources, such as one or more physical access resources and/or one or more virtual access resources. Physical access resources can include base station(s) (e.g., one or more eNodeBs, one or more gNodeBs, or the like, such as base stations 206b), one or more satellites, one or more Gigabyte Passive Optical Networks (GPONs) or related components (e.g., Optical Line Terminal(s) (OLT), Optical Network Unit(s) (ONU), etc.), and/or the like. A base station may employ any suitable radio access technology (RAT), such as 4G/LTE, 5G, 6G, or any higher generation RAT.

One or more edge computing devices (e.g., multi-access edge computing (MEC) devices or the like) may also be included in or associated with the access network 210. Virtual access resources can include a voice service system (e.g., a hardware and/or software implementation of voice-related functions), a video service system (e.g., a hardware and/or software implementation of video-related functions, such as coder-decoder or compression-decompression (CODEC) components or the like), a security service system (e.g., a hardware and/or software implementation of security-related functions), and/or the like. In one or more embodiments, the access network 210 may include any number/types of physical/virtual access resources and various types of heterogeneous cell configurations with various quantities of cells and/or types of cells.

In certain embodiments, the access network 210 may be implemented as a virtual RAN, where radio/wireline functions are implemented as general-purpose applications/apps that operate in virtualized environments and interact with physical resources either directly or via full/partial hardware emulation. Virtualized software radio applications can be delivered as a service and managed through a cloud controller. Here, base stations may be implemented as (e.g., passive) distributed radio elements connected to a centralized baseband processing pool. In some embodiments, the access network 210 may include, or communicate with, a RAN intelligent controller (RIC).

The system 200 can provide services to various types of UEs 202, 203, 204 and 205 (collectively, UE 206). Examples of UEs 206 include mobile devices 204, display and television devices, home and business networks, IoT devices, video and audio devices, autonomous vehicles 205, unmanned aerial vehicles (UAVs) 203, and so on. The UEs 206 may be equipped with one or more transmitter (Tx) devices and/or one or more receiver (Rx) devices configured to communicate with, and utilize network resources of, the system 200.

UAVs may include any (e.g., manually controllable or autonomous) personal or commercial aerial vehicle or device that is equipped with one or more types of devices or components for performing various actions. In certain embodiments, UAVs may include one or more radio equipment configured to function as a cellular relay (e.g., low-powered cellular radio access (or small cell) node(s)), one or more sensors (e.g., image sensor(s), infrared sensor(s), near infrared camera(s), radar system(s), light detection and ranging (LIDAR) system(s), biological sensor(s), temperature sensor(s), chemical sensor(s), humidity sensor(s), and/or the like) for capturing information/data in an environment of UAVs, one or more mechanical limbs for physically manipulating external objects, and/or the like. In some embodiments, one or more UAVs may be deployed to provide network connectivity for other UE(s). In certain embodiments, UAVs may provide network connectivity by way of wireless “tethering” to (e.g., a base station or the like of) an access network like the access network 210 or a different access network (i.e., one that is not experiencing a traffic surge condition) and/or via a wired link (e.g., over a fiber connection) to a network device (e.g., edge computing device or the like) that has a backhaul connection to the mobile network platform. UAVs may, additionally, or alternatively, communicate data (e.g., control data, user data, etc.) via the wireless tethering or wired link.

The 3rd Generation Partnership Project (3GPP) network groups has been researching the ability for aerial vehicles to be served using LTE network deployments with base station antennae targeting terrestrial coverage. This study item has been expected to be become a proposed feature set for 5G technologies. Many use cases of unmanned aerial vehicles (UAVs) require beyond visual line-of-sight (LOS) communications. Mobile networks offer wide area, high speed, and secure wireless connectivity, which can enhance control and safety of UAV operations and enable beyond visual LOS use cases. Existing LTE networks can support initial drone deployments. LTE evolution and 5G will provide more efficient connectivity for wide-scale drone deployments.

In various embodiments, a location of the UAV 203 in an idle state is known by the network based on a Tracking Area (TA) granularity in the context of the 3GPP network, as depicted in FIG. 2A. A Tracking area (TA) includes a cluster of base stations such as eNBs/gNBs having the same tracking area code and represents an area in which the UAV 203 was last registered, as shown in FIG. 2A. Aerial UEs such as the UAV 203 may go to an idle mode, where UAVs may not send or receive data for a certain period of time. Specifically, the idle mode will more likely happen with autonomous vehicles (UAV or cars) as such vehicles are not piloted by human operators but rather have intelligence limited to make driving decisions. Under these circumstances, aerial UEs can enter the idle mode, as depicted in FIG. 2A.

For instance, the UAV 203 may enter the idle mode. In the idle mode, the UAV 203 moves out of a last serving cell and then may camp into another cell in a wireless communication network such as terrestrial LTE/5G networks, as illustrated in FIG. 2A. The exact location of the UAV 203 may be unknown in the idle mode. If the UAV 203 needs to be contacted quickly, either for sending data or requesting a location update, then the mobile network platform 220, more specifically, the MME 223 will send a paging message to the last base station (e.g., eNB/gNB) where the UAV 203 was attached. If the mobile network platform 220 cannot find the UAV 203, the mobile network platform 220 may increase radios of base stations and send again a second paging message. This process will continue until the UAV 203 can be located, which may induce delays, for instance, if the UAV 203 has moved far away in the idle mode.

As depicted in FIG. 2A, the access network 210 uses the Radio Resource Control (RRC) protocol and includes other components such as a Media Access Control (MAC) function and a physical layer (PHY). Functions of the RRC protocol include connection establishment and release functions, broadcast of system information, radio bearer establishment, reconfiguration and release, paging notification and release, etc. By signaling functions, the RRC configures user and control planes according to the network status and allows for radio resource management strategies to be implemented.

In various embodiments, when the UAV 203 is in idle mode and moves from one TA to another (see FIG. 2A), the UAV 203 needs to send a tracking area update (TAU) message to update the MME 223 as to a location of the UAV 203. Conversely, the mobile network platform 220 can configure the UE 206 to send periodically TAU messages, even if the UAV 203 is still in the same tracking area. A periodicity of a TAU message indicates a transmission frequency of the TAU message by the UE 206 to a network counterpart element. In other words, the TAU periodicity refers to how often the TAU message is sent by user equipment to the network counterpart. Increasing the TAU periodicity refers to enlarging a number of TAU messages over a period of time, and decreasing the TAU periodicity refers to reducing a number TAU messages over a period of time.

In various embodiments, the periodicity of the TAU messages is provided by the mobile network platform 220 to the UAV 203 via the access network 210, more specifically in an RRC.Connection.Reconfiguration message which is sent during the attachment procedure. The TAU messages configuration by the RRC functions is not limited to the UAV 203 and can be applied to other UEs included in the UE 206. The TAU messages include configuration information of the TAU periodicity such as a number of TAU messages or a transmission frequency of TAU messages over a predetermined period of time to be sent by UE to a network counterpart. Additionally, an identity of a last serving cell that the UAV is known to have been attached to is provided in a latest TAU message sent by the user terminal to the network counterpart element.

Among different UEs included in the UE 206, aerial UEs (e.g., UAVs) may go to an idle mode sometimes, as the aerial UEs operate as autonomous vehicles, i.e., not piloted by humans and by rather have enough intelligence to make driving decisions. Under these circumstances, the aerial UEs can enter an idle mode. The aerial UEs may include certain unique operation conditions to be taken into consideration in connection with the idle mode, for instance, a limited battery supply and capabilities to quickly move far away from a serving cell.

By way of example, if an aerial UE (e.g., the UAV 203 in FIG. 2A) is in the idle mode, and moves out of its last serving cell, then UAV 203 may camp into another cell. The mobile network platform 220 is not aware of the exact location of the UAV 203 in the idle mode. If the mobile network platform 220 needs to contact the UAV 203 quickly, either to send data or to request a location update, then mobile network platform 220 will send, via the MME 223, a paging message to the last serving cell that the UAV 203 was attached to. If the mobile network platform 220 can find the UAV 203, the mobile network platform 220 will increase the radios of the base station and send again a second paging message, the process will continue until the UAV 203 is located. This process may induce delays, if UAV 203 has moved far away while in the idle mode.

Additionally or alternatively, the UAV 203 can send Tracking Area Update (TAU) messages periodically to the mobile network platform 220 to provide location updates. The periodicity of the TAU messages is included in an RRC.Connection.Reconfiguration message, which is sent during the attachment procedure. In some embodiments, all the UEs attached to the network receives the same RRC.Connection.Reconfiguration message and therefore, follow the same TAU periodicity. In some embodiments, an aggressive TAU periodicity can yield a battery power drainage. The aggressive TAU periodicity, however, can provide a more granular level of location estimation of the UAV 203 as the TAU messages can be used to estimate the location of the UAV 203. Recommendations about the periodicity of TAU messages periodicity for aerial UEs are needed.

In various embodiments, the mobile network platform 220 includes a logic 224 which performs a tracking area update method. For instance, in the LTE networks, when data is received at the SGW 221 for the UAV 203, the UAV 203 may be in the idle mode. In the idle mode, the UAV 203 may not receive or send data for a period of times. This may happen where autonomous vehicles such as unmanned aerial vehicles (UAVs) or cars are not piloted by humans but rather operate themselves based on a threshold level intelligence to make driving decisions. For instance, UAVs may move out of the last serving cell and may camp into another cell.

In the idle mode, the SGW 221 buffers the data and sends a downlink (DL) data notification request to the MME 223. The wireless communication network may not be aware of the exact location of the UAV 203 while in the idle mode. If the wireless communication network needs to contact the UAV 203 such as UAVs quickly, in order to either send data or request a location update, the MME 223 initiates a paging procedure by sending paging messages to the UAV 203 through one or many cells in the network. The MME 223 starts by sending a paging message to the last serving cell that the UAV 203 was attached to.

In various embodiments, in response to the paging message, if the MME 223 does not receive a reply from the UAV 203, then MME 223 sends paging messages to several cells nearby the last serving cell that the UE 206 was attached to. In response to the paging messages, if the MME 223 still does not receive a reply from the UAV 203, then the MME sends paging messages to all of the cells belonging to a tracking area (TA) in which the UAV 203 is registered. The tracking area (TA) comprises a cluster of base stations having a same tracking area code and represents an area where the UAV 203 was last registered. The UAV 203 can then respond to the paging messages and notify a serving cell of the UAV 203. Wireless Operators try to place the same number of base stations such as eNBs on each TA in order to keep a paging overhead of the base stations to a maximum predefined value.

FIG. 2B depicts an illustrative embodiment of a method 240 in accordance with various aspects described herein. In various embodiments, the method 240 includes receiving user equipment (UE) identification of a UE operating in a tracking area (Step 242). The tracking area includes a cluster of base stations having a same tracking area code and represents an area where the UE was last registered (Step 242). The method 240 includes, based on the received UE identification, identifying that a type of UE is an unmanned aerial vehicle (UAV) attached to a serving cell included in the cluster of base stations (Step 244). For instance, the method 240 can distinguish aerial UEs from terrestrial UEs based on International Mobile Subscriber Identity (IMSI) or any other UE Identifier or UE.Subscription.Identifier.

The method 240 further includes, upon the identification of the UAV, determining, by the processing system, that the UAV is in an idle mode and sending a notification to the UAV (Step 246). For instance, upon the identification that the aerial UE (UAV) is attached to the network and it is likely that this UAV is an autonomous vehicles, then the mobile network sends a notification to the UAV (Step 246).

In various embodiments, while in operation, the UAV detects and collect operation conditions of the UAV, such as a speed, a location, battery level power statistics, or a combination thereof. The method 240 also includes receiving, from the UAV, a message including a requested periodicity of a tracking area update (TAU) (Step 247). The UAV is configured to send a message including a requested periodicity of a tracking area update (TAU) to the mobile network, in response to the detected and collected operation conditions of the UAV. For instance, the message may include a field, “TAU.Requested.Periodicity.” The mobile network receives the message including the field, “TAU.Requested.Periodicity” from the UAV (Step 247).

Upon receiving a value for the “TAU.Requested.Periodicity,” the mobile network updates a TAU periodicity to be aligned with the requested periodicity of the TAU (Step 248). A periodicity of a TAU message indicates a transmission frequency of the TAU message by the UE 206 to a network counterpart element. In other words, the TAU periodicity refers to how often the TAU message is sent by user equipment to a network counterpart. Increasing the TAU periodicity refers to enlarging a number of TAU messages over a period of time, and decreasing the TAU periodicity refers to reducing a number TAU messages over a period of time. The TAU messages include configuration information of the TAU periodicity such as a number of TAU messages or a transmission frequency of a TAU message over a predetermined period of time to be sent by UE to a network counterpart. Additionally, an identity of a last serving cell that the UAV is known to have been attached to is provided in the latest TAU message sent by the user terminal to the network counterpart element. The mobile network will mandate a serving cell of the UAV to send an updated message including the updated periodicity of the TAU (Step 249). For instance, the updated message further includes an updated RRC.Connection.Reconfiguration message to the UAV.

By way of example, a “TAU.Periodicity” value is aligned with “TAU.Requested.Periodicity” as follows.
The UAV detects high mobility, and/or high battery level power. Then, the UAV mandates “TAU.Requested.Periodicity”=Aggressive. The mobile network receives the “TAU.Requested.Periodicity” message and reacts by mandating serving cell to use “TAU.Periodicity”=Small for this UAV. A small time interval value for the TAU periodicity indicates more frequent transmission of a TAU message. As another example, “TAU.Periodicity” can be configured as a frequency or a number of TAU messages and then, it is set: “TAU.Periodicity”=Large.
The UAV detects high low/no mobility, and low battery level power. Then, the UAV mandates “TAU.Requested.Periodicity”=Relaxed. The mobile network receives the “TAU.Requested.Periodicity” message and reacts by mandating serving cell to use “TAU.Periodicity”=Large for this UAV. A large time interval value for the TAU periodicity indicates less frequent transmission of a TAU message. As another example, “TAU.Periodicity” can be configured as a frequency or a number of TAU messages and then, it is set: “TAU.Periodicity”=Small.

In various embodiments, the UAV will constantly monitor changes in UAV conditions (speed, location, and battery level power) to send updated “TAU.Requested.Periodicity”, if and as needed.

In various embodiments, the receiving the message (Step 247) further comprises receiving the message including the requested periodicity of the TAU that is correlated to operation conditions of the UAV. The operation conditions of the UAV further comprise a speed of the UAV, a location of the UAV, a battery level of the UAV, or a combination thereof. A time interval value for the updated periodicity of the TAU increases (i.e., the UAV less frequently transmits TAU messages and TAU messages are sent with a longer time interval) as a mobility level of the UAV decreases. Additionally or alternatively, a time interval value for the updated periodicity of the TAU increases (i.e., the UAV less frequently transmits TAU messages and TAU messages are sent with a longer time interval) as a battery power level of the UAV decreases. The updated message comprises an updated radio resource control connection reconfiguration message including the updated periodicity of the TAU. Additionally, the method further includes receiving an updated message including a modified requested periodicity of the TAU reflecting a change to operation conditions of the UAV.

As depicted in FIG. 2A, the MME will use the last cell that served the UAV, which was notified in its TAU message, to deliver a paging message, if data is received for UAV and if UAV is the idle mode. There is high likelihood of UAV is camped to this cell. Conversely, the method 240 can mandate the MME 223 to deliver paging messages to a small number of cells nearby the last cell that served the UAV (which was notified by UAV in its TAU message), e.g., cells within 5 miles, by way of example only. In various embodiments, the cell-radius can be estimated based on observations of different results. In various embodiments, the method 240 will use machine learning and prediction techniques, mathematical models, etc. to update a TAU periodicity for aerial UEs based on network conditions.

FIG. 2C depicts an illustrative embodiment of another method 250 in accordance with various aspects described herein. The method 250 includes receiving a configuration message including a periodicity of a tracking area update (TAU) during an initial attachment, where the periodicity of the TAU is indicative of a transmission frequency of the TAU by a user equipment to a network counterpart element (Step 252), and sending the TAU to the mobile network via a serving cell according to the periodicity of the TAU included in the received message (Step 254). The method 250 further includes collecting operation conditions of an aerial user equipment (UE), wherein the aerial UE operates as an autonomous vehicle (Step 256); transmitting a message including a requested periodicity of the TAU based on the collected operation conditions (Step 257); receiving, via the serving cell, a reconfiguration message including an updated periodicity of the TAU that is consistent with the requested periodicity of the TAU (Step 258); and providing the TAU based on the updated periodicity (Step 259).

In various embodiments, the method 250 further comprises detecting the operation conditions of the aerial UE including a mobility level of the UE, a battery level of the UE, or a combination thereof, collecting the detected operation conditions of the aerial UE, and updating the periodicity of the TAU based on the detected operation conditions of the aerial UE. The receiving the configuration message (Step 252) further comprises receiving a radio resource control connection reconfiguration message during the initial attachment. A time interval value for the updated periodicity of the TAU decreases as a mobility level of the UAV, a battery power level, or both increase. In various embodiments, the updated periodicity of the TAU is set to be less frequent or a smaller number of TAU messages in response to no mobility or lower mobility level of the aerial UE, and a lower battery power level of the aerial UE or both, compared to the operation conditions of the aerial UE at the time of the initial attachment.

In various embodiments, the method further includes receiving one or more paging messages from a mobile network via a last serving cell that the aerial UE is known to have been attached to, one or more nearby cells of the last serving cell, or all of cells belonging to a tracking area in which the aerial UE was registered. The method further includes transmitting a response to the one or more paging messages and notifying the mobile network of the serving cell.

In various embodiments, the updating the TAU periodicity further comprises updating, by the processing system, the TAU periodicity using a machine learning algorithm, mathematical models, etc. The method includes receiving additional messages including an updated requested periodicity of the TAU in response to a change to operation conditions of the aerial UE.

In various embodiments, the TAU periodicity refers to how often a TAU message is sent by the user equipment to a network counterpart. Increasing the TAU periodicity refers to enlarging a number TAU messages over a period of time, and decreasing the TAU periodicity refers to reducing a number TAU messages over a period of time. Additionally, or alternatively, increasing the TAU periodicity refers to reducing a time interval between TAU messages over a period of time, and decreasing the TAU periodicity refers to increasing a time interval between TAU message over a period of time. In certain embodiments, the TAU message is used by the mobile network to estimate UAV location, and an increase of the TAU periodicity refers to a more granular UAV location estimation, potentially at the expenses of UAV battery drainage. Additionally, an identity of a last serving cell that the UAV is known to have been attached to is provided in a latest TAU message send by the UAV to the network counterpart element.

While for purposes of simplicity of explanation, the respective processes are shown and described as a series of blocks in FIGS. 2B and 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In various embodiments, a system and method will use machine learning and prediction techniques, mathematical models, etc. to update tracking area update (TAU) periodicity for unmanned aerial vehicles (UAVs) based on UAVs and network conditions. The system and method include collecting speed, location, and battery level power statistics of an UAV, mandating the UAV to send a request to a network with a field, “TAU.Requested.Periodicity.” Upon receiving the “TAU.Requested. Periodicity” value, the system and method include mandating a serving cell to send an updated RRC.Connection.Reconfiguration message to the UAV which should include a “TAU.Periodicity” value that is aligned with “TAU.Requested.Periodicity”.

In the above described embodiments, the smart tracking area update systems and methods provide the mechanism for fast paging and response for aerial UEs, while they are in an idle mode in order to reduce transmission delays associated with the paging and reply process, for instance, which may occur when UAV is traversing a dense network. The smart tracking area update systems and methods can be beneficial to wireless operators that are using or planning to use terrestrial wireless communication networks such as LTE/5G networks to serve UAVs.

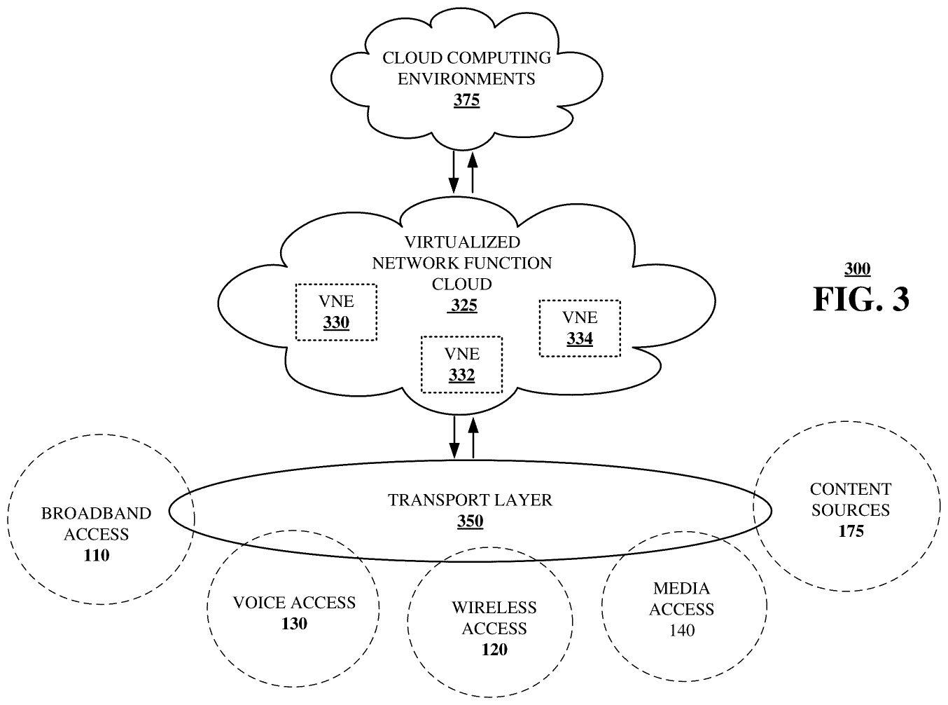

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part tracking area update systems and methods for aerial user equipment (UE) in wireless communication networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

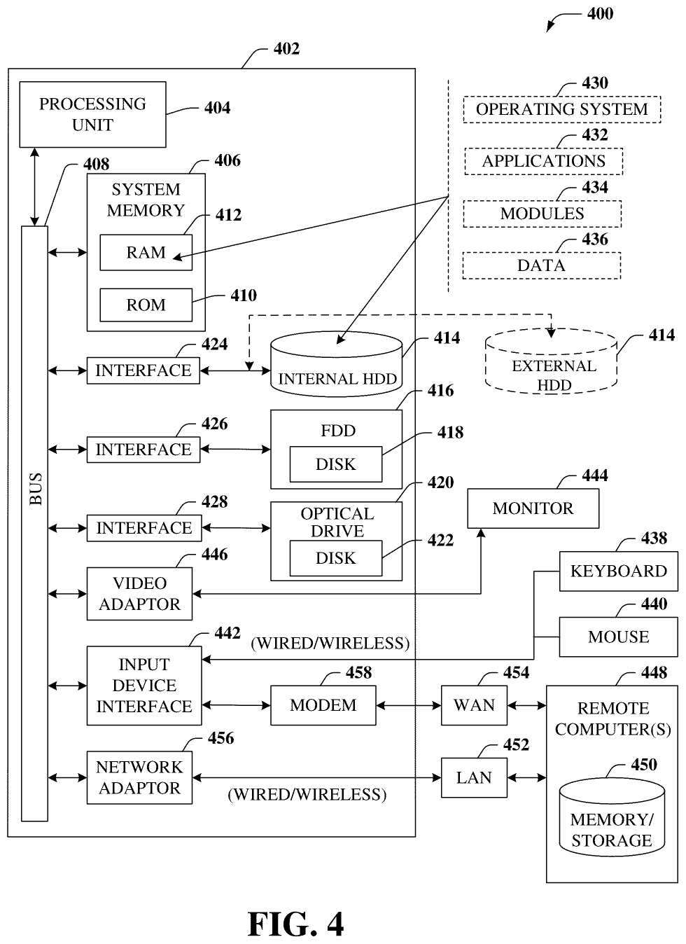

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part tracking area update systems and methods for aerial user equipment (UE) in wireless communication networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

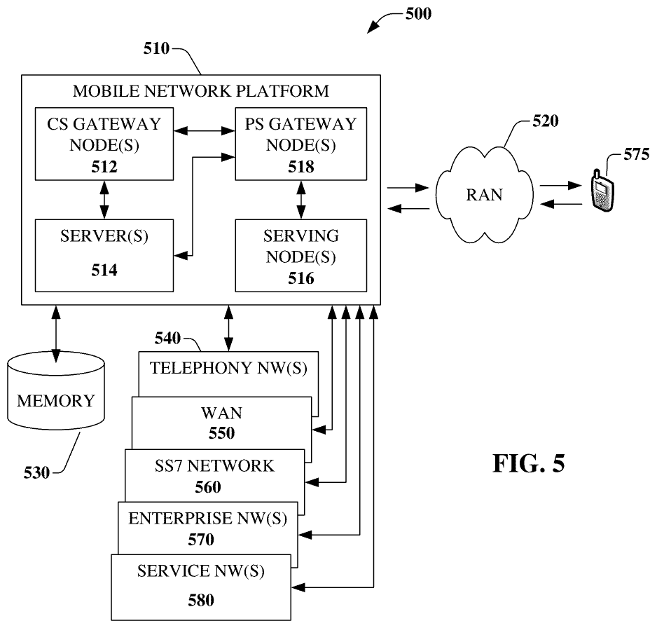

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part tracking area update systems and methods for aerial user equipment (UE) in wireless communication networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology (ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

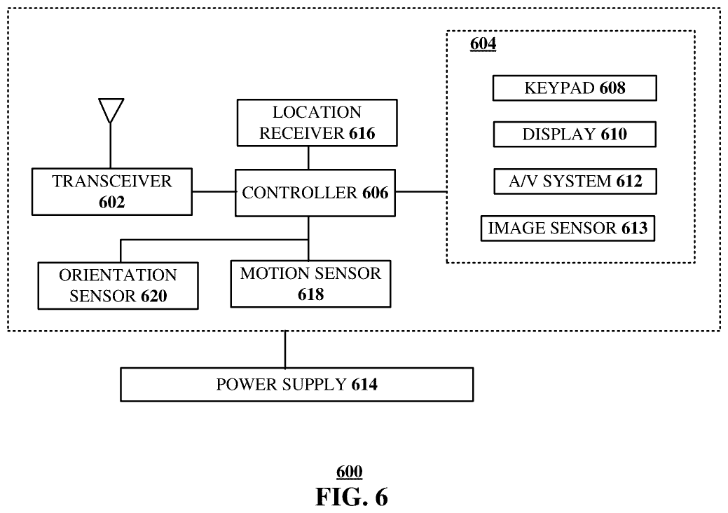

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part tracking area update systems and methods for aerial user equipment (UE) in wireless communication networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

One or more of the embodiments described herein can be combined in whole or in part with the embodiments described in co-pending U.S. patent application Ser. No. 18/659,103 (having Attorney Docket No. 2023-0029_7785-3177A), entitled “TRACKING AREA UPDATE MANAGEMENT SYSTEMS AND METHODS FOR AERIAL USER EQUIPMENT OVER WIRELESS COMMUNICATION NETWORKS,” filed on even date herewith. For instance, embodiments of the aforementioned U.S. application can be combined in whole or in part with embodiments of the subject disclosure. For example, one or more features and/or embodiments described in the aforementioned U.S. application can be used in conjunction with (or as a substitute for) one or more features and/or embodiments described herein, and vice versa. Accordingly, all sections of each of the aforementioned U.S. application are incorporated herein by reference in their entirety.

What is claimed is:

1. A device, comprising:
a processing system including a processor; and
a memory that stores executable instructions that, when executed by the processing system, facilitate performance of operations, the operations comprising:
receiving user equipment (UE) identification of a UE operating in a tracking area, wherein the tracking area comprises a cluster of base stations having a same tracking area code and represents an area where the UE was last registered;
based on the received UE identification, identifying that a type of UE is an unmanned aerial vehicle (UAV) attached to a serving cell included in the cluster of base stations;
upon the identification of the UAV, determining that the UAV is in an idle mode and sending a notification to the UAV;
receiving, from the UAV, a requested periodicity of a tracking area update (TAU);
upon the receipt of the requested periodicity of the TAU, updating a TAU periodicity to be aligned with the requested periodicity of the TAU; and
mandating the serving cell of the UAV to send to the UAV an updated message including the updated TAU periodicity,
wherein the TAU periodicity is indicative of a transmission frequency of a TAU message over a predetermined period of time by the UE to a network counterpart.

2. The device of claim 1, wherein the receiving the requested periodicity of the TAU further comprises receiving the requested periodicity of the TAU that is responsive to operation conditions of the UAV.

3. The device of claim 2, wherein the operation conditions of the UAV further comprise a speed of the UAV, a location of the UAV, a battery level of the UAV, or a combination thereof.

4. The device of claim 1, wherein the transmission frequency of the updated TAU periodicity increases as a mobility level of the UAV increases.

5. The device of claim 1, wherein the transmission frequency of the updated TAU periodicity decreases as a battery power level of the UAV decreases.

6. The device of claim 2, wherein the updated message comprises an updated radio resource control connection reconfiguration message including the updated TAU periodicity.

7. The device of claim 1, wherein the operations further comprise estimating a location of the UAV based on the TAU message, wherein an increased transmission frequency of the updated TAU periodicity facilitates a granular estimation of the location of the UAV.

8. A machine-readable medium, comprising executable instructions that, when executed by a processing system of an aerial user equipment including a processor, facilitate performance of operations, the operations comprising:
receiving a configuration message including a periodicity of a tracking area update (TAU) during an initial attachment, wherein the TAU periodicity is indicative of a transmission frequency of a TAU message over a predetermined period of time by an aerial user equipment (UE) to a network counterpart element;
sending the TAU message to the network counterpart element via a serving cell according to the TAU periodicity;
collecting operation conditions of the aerial UE, wherein the aerial UE operates as an autonomous vehicle;
transmitting a requested periodicity of the TAU based on the collected operation conditions of the aerial UE to the network counterpart element;
receiving, via the serving cell, a reconfiguration message including an updated periodicity of the TAU that is consistent with the requested periodicity of the TAU; and
transmitting, over the predetermined period of time, the TAU message a number of times determined based on the updated periodicity of the TAU included in the reconfiguration message.

9. The machine-readable medium of claim 8, wherein the operations further comprise:
detecting the operation conditions of the aerial UE including a mobility level of the UE, a battery level of the aerial UE, a location of the aerial UE, or a combination thereof; and
updating the requested periodicity of the TAU based on the detected operation conditions of the aerial UE.

10. The machine-readable medium of claim 9, wherein the operations further comprise determining that the detected operation conditions of the aerial UE correspond to an idle mode of the aerial UE.

11. The machine-readable medium of claim 10, wherein the operations further comprise providing to the network counterpart element, in a latest TAU message, an identity of a last serving cell, after the determination of the idle mode of the aerial UE, that the aerial UE is known to have been attached to.

12. The machine-readable medium of claim 9, wherein the updated periodicity of the TAU is set to be less frequent in response to no mobility or lower mobility level of the aerial UE and a lower battery power level of the aerial UE, compared to the operation conditions of the aerial UE at a time of the initial attachment.

13. The machine-readable medium of claim 8, wherein the operations further comprise receiving one or more paging messages from the network counterpart element via a last serving cell that the aerial UE is known to have been attached to, one or more nearby cells of the last serving cell, or all of cells belonging to a tracking area in which the aerial UE was registered.

14. The machine-readable medium of claim 13, wherein an identity of, the last serving cell that the aerial UE is known to have been attached to, is provided in a latest TAU message sent by the aerial UE to the network counterpart element, and the receiving one or more paging messages further comprises receiving one or more paging messages via the last serving cell having the identity included in the latest TAU message, wherein the identity included in the latest TAU message is utilized by the network counterpart element for sending the one or more paging messages.

15. A method, comprising:
identifying, by a processing system including a processor, a type of user equipment (UE) and an unmanned state of the UE, based on a UE identifier;
upon the identification that the type of user equipment corresponds to an unmanned aerial UE attached to a wireless communication network, determining, by the processing system, that the unmanned aerial UE is in an idle mode;
upon the determination of the idle mode of the unmanned aerial UE, sending, by the processing system, a paging message to a last serving cell included in a tracking area update (TAU) message that have received from the unmanned aerial UE;
receiving, by the processing system, from the unmanned aerial UE, a requested periodicity of the TAU;
upon the receiving of the requested periodicity of the TAU, updating, by the processing system, a TAU periodicity reflecting the requested periodicity of the TAU, wherein the TAU periodicity is indicative of a transmission frequency of a TAU message over a preset period of time by the unmanned aerial UE to a network counterpart; and
mandating, by the processing system, a serving cell of the unmanned aerial UE to send an updated reconfiguration message including the updated TAU periodicity.

16. The method of claim 15, further comprising:
upon receiving no response to the paging message sent to the last serving cell, sending, by the processing system, additional paging messages to serving cells nearby the last serving cell within a predetermined cell radius.

17. The method of claim 16, further comprising:
in response to the paging message, the additional paging messages or both, receiving, by the processing system, information regarding the serving cell of the unmanned aerial UE, wherein the serving cell of the unmanned aerial UE is identical to or different from the last serving cell included in the TAU message prior to the determination of the idle mode of the unmanned aerial UE.

18. The method of claim 16, wherein a time interval of the TAU message according to the updated TAU periodicity decreases as a mobility level of the unmanned aerial UE, a battery power level, or both increase.

19. The method of claim 15, wherein the updating the TAU periodicity further comprises updating, by the processing system, the TAU periodicity using mathematical prediction models or a machine learning algorithm.

20. The method of claim 15, further comprising receiving, by the processing system, the TAU message including receiving a latest TAU message containing an identity of a last serving cell, after the determination of the idle mode, that the unmanned aerial UE is known to have been attached to.
